(19) United States
(12) Patent Application Publication
(10) Pub. No.: US 2004/0234282 A1
(43) Pub. Date: Nov. 25, 2004

(54) Image forming apparatus

(75) Inventors: Shigemichi Hamano, Chiba (JP); Akihiko Sato, Chiba (JP); Shinichi Takata, Chiba (JP); Toru Ono, Ibaraki (JP); Yushi Oka, Chiba (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/793,793

(22) Filed: Mar. 8, 2004

(30) Foreign Application Priority Data
Mar. 10, 2003 (JP) 2003-063266 (PAT.

(51) Int. Cl. G03G 15/08

(52) U.S. Cl. 399/27; 399/227

(57) ABSTRACT

When a plurality of toner containers mounted on a developing rotary is simultaneously determined as toner-absent toner containers, toner container replacement may not be efficient because toner containers are replaced at on replacement position. Therefore, when the toner containers mounted on the developing rotary are simultaneously determined as toner-absent toner containers, a toner container to be preferentially replaced is selected so as to be able to a replacement position by considering the usability.

### BACKGROUND OF THE INVENTION

1. Field of the Invention

The present invention relates to an image forming apparatus using an electrophotographic system or electrostatic recording system, particularly to an image forming apparatus for a copying machine, printer, FAX, or a complex machine having functions of them.

2. Related Background Art

A full-color-image forming apparatus using an electrophotographic system is hitherto proposed which makes it possible to sequentially execute developing operations by selectively rotating a desired developing apparatus to a developing position by a developing rotary mounting a plurality of corresponding toner cartridges (toner containers) together with a plurality of developing apparatuses.

The above image forming apparatus is constituted so as to remove a toner cartridge with no toner among a plurality of toner cartridges from the developing rotary and replace it with a new one.

However, when a plurality of toner cartridges runs short of toner or decreases in toner at the same time, a technique is requested which allows a user to replace toner cartridges without confusion of the user by considering the replaceability or usability of the a toner container.

### SUMMARY OF THE INVENTION

It is an object of the present invention to provide a high-usability image forming apparatus superior in replaceability of a toner container held by a movable body.

It is another object of the present invention to provide an image forming apparatus improved in usability such as allowing the time for replacing a toner container held by a movable body to decrease or allowing an image forming job after replacing a toner container to be efficiently executed.

It is still another object of the present invention to provide an image forming apparatus without confusion of a user when replacing toner containers.

The above and other objects of the present invention will become more apparent by reading the following detailed description while referring to the accompanying drawings.

### BRIEF DESCRIPTION OF THE DRAWINGS

FIG. 1 is an illustration showing a schematic configuration of a an image forming apparatus;

FIG. 2 is a block diagram of a control processing portion of an image forming apparatus;

FIG. 3 is a flowchart for image information processing from CCD input when reading an image up to a printer controlling potion;

FIG. 4 is an illustration showing a flow of toner replenishment amount correction according to a patch detection result;

FIG. 5 is a toner-absence detection control flow;

FIG. 6A is a movement flow of a developing rotary to a toner container ejection position when absence of a plurality of color toners including absence of black toner occurs, FIG. 6B is a movement flow of a developing container to a toner container ejection position when absence of a plurality of color toners excluding absence of black toner occurs; and FIG. 6C is a movement flow of a selected color key-input by a user from an operating portion to a toner container ejection position;

FIG. 7 is a schematic view of a toner replacing small window;

FIG. 8A is a an illustration showing the normal home position of a developing rotary, FIG. 8B is an illustration showing the home position of a developing rotary when a full color image is formed and a final color image formation is completed, and FIG. 8C is an illustration showing a magenta-toner-container ejection position;

FIG. 9 is an illustration showing a toner initialization control flow immediately after replacing toner;

FIG. 10 is a schematic view showing sides of a toner container and a developing apparatus; and

FIG. 11 is an enlarged view showing the replenishment port in a toner container and the entrance of the toner replenishment route in a developing apparatus.

### DESCRIPTION OF THE PREFERRED EMBODIMENTS

Embodiment 1

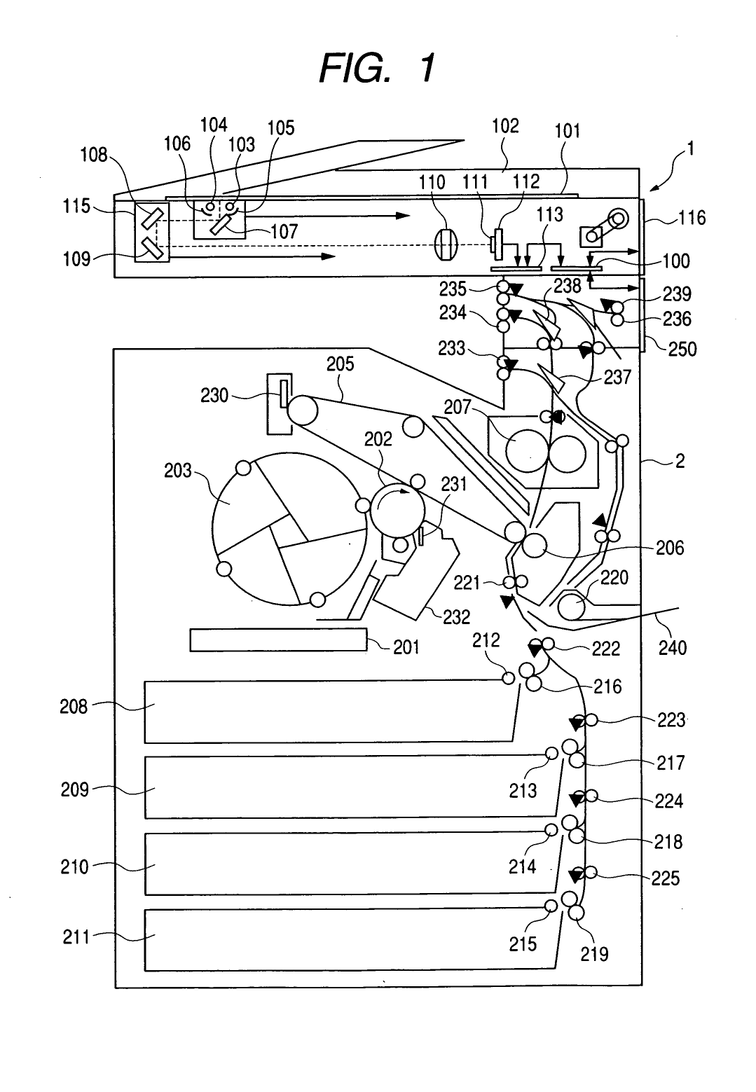

FIG. 1 is an illustration showing a schematic configuration of a full-color image forming apparatus which is an embodiment of the present invention. A basic configuration is described below by referring to FIG. 1.

(Image Forming Sequence)

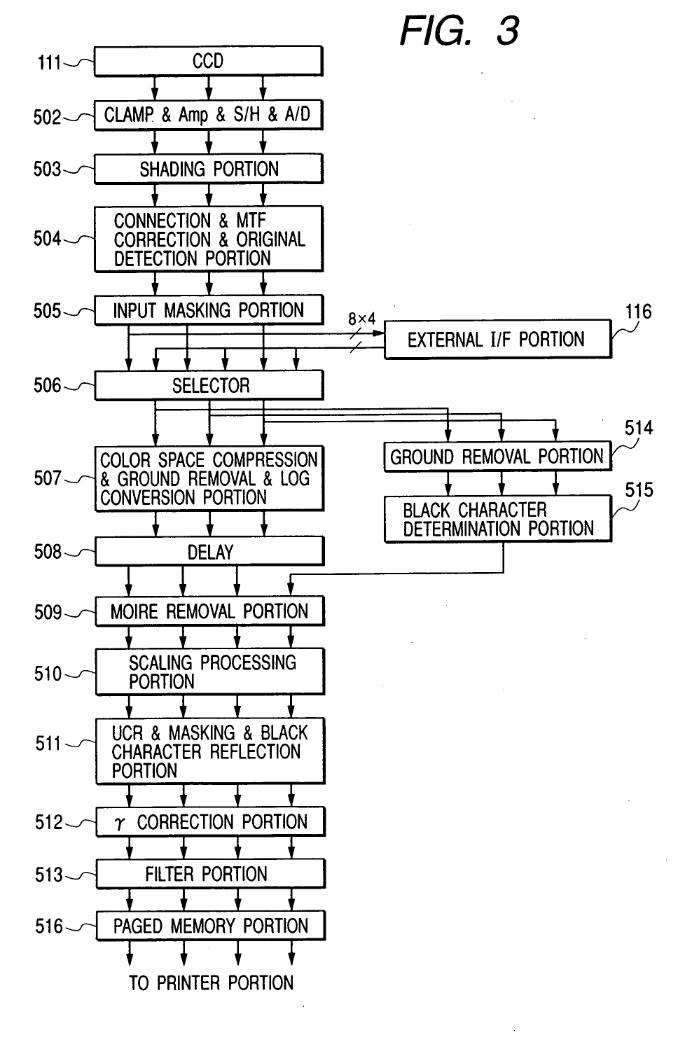

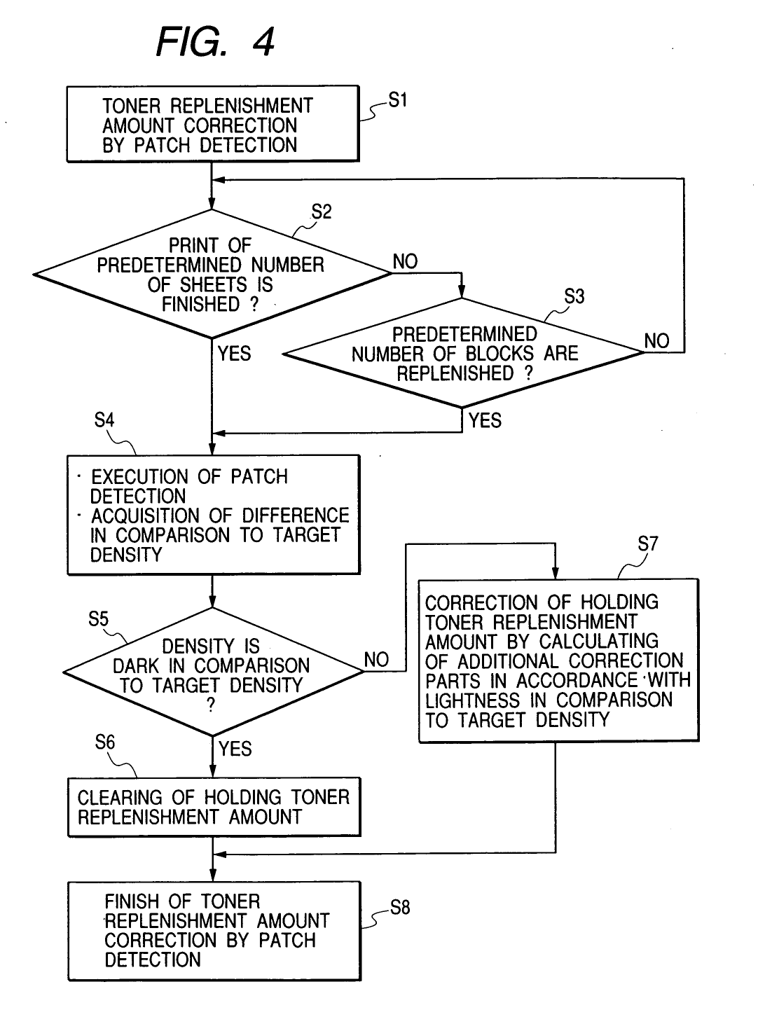

First, a configuration of a color reader portion 1 is described below. Symbol 101 denotes original mounting table glass (platen) and 102 denotes an automatic original feeder (ADF). It is also allowed to use a configuration for setting a mirror-surface pressure plate or white pressure plate (not illustrated) instead of the automatic original feeder 102. Symbols 103 and 104 denote light sources for illuminating an original, which respectively use a light source such as a halogen lamp, fluorescent lamp, xenon tube lamp. Symbols 105 and 106 denote reflection umbrellas for condensing the light emitted from the light sources 103 and 104 on an original. Symbols 107 to 109 denote mirrors and 110 denotes a lens for condensing the light reflected or projected from an original on a CCD (charge coupled device) image sensor (hereafter referred to as CCD) 111. Symbol 112 denotes a substrate on which the CCD 111 is mounted, 100 denotes a controlling portion for controlling the whole of an image forming apparatus, and 113 denotes a printer processing portion (reader scanner controlling portion) including the portion of the image processing portion in FIG. 4 excluding 111 and the portions of 401 and 402 in FIG. 3. Symbol 114 denotes a carriage for receiving the light sources 103 and 104 and reflection umbrellas 108 and 109. The carriage 114 scans the entire surface of an original by mechanically moving in the subscanning direction Y orthogonal to the electrical scanning direction (main scanning direction X) of the CCD 111 at a speed of V/2. Symbol 116 denotes an external interface (I/F) with other device.

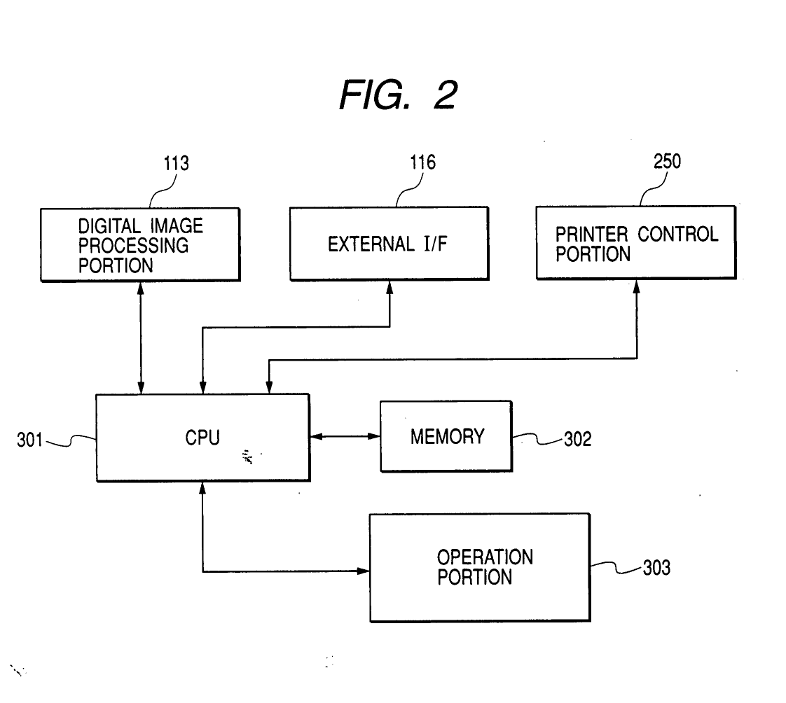

Moreover, as shown in FIG. 2, the controlling section 100 is constituted by a CPU 301 having an I/F for exchanging the information for performing control with the digital image processing portion 113 and a printer controlling portion 222, an operating portion 303 and a memory 302. The operating portion 303 is constituted by a liquid crystal display provided with a touch panel for inputting processing execution contents by an operator and communicating the information on processing and a warning for the operator.

Then, the digital image processing portion 113 is described below in detail. FIG. 4 is a block diagram showing a detailed configuration of the digital image processing portion 113.

The light emitted from the light sources 103 and 104 on the original table glass is reflected and the reflected light is guided to the CCD 11 and converted into electrical signals (when the CCD 111 is a color sensor, it is allowed to use a sensor in which color filters of R, G and B are set on a one-line CCD in order in-line, a sensor in which R, G and B filters are arranged for each CCD of a three-line CCD, or a sensor a filter is set on a chip or constituted separately from a CCD). Moreover, the electrical signals (analog image signal) are input to the image processing portion 113, sample-held (S/H) by a clamp&Amp&S/H&A/D portion 502 and dark levels of the analog image signals are clamped to a reference potential and amplified to predetermined amounts (the above processing sequence is not always a notation sequence), and the image signals are A/D-converted into, for example, 8-bit digital signals of R, G and B respectively. Then, the R, G and B signals undergo shading correction and black correction in a shading portion 503. Then, a delay amount for each line is adjusted by a bond&MTFcorrection&original detecting portion 503 in accordance with a read speed because in the case of bond processing, a position between lines differs when the CCD 113 is a three-line CCD, signal timing is corrected so that read positions of three lines become the same, a change of MTF for read is corrected because the MTF for read depends on a read speed or power-varying rate in the case of MTF correction, and an original size is recognized by scanning the original on the original table glass in the case of original detection. A digital signal whose read timing is corrected corrects the spectral characteristic of the CCD 111 and spectral characteristics of the originals 103 and 104 and reflection umbrellas 105 and 106 by an input masking portion 505. An output of the input masking portion 505 is input to a selector 506 which can be switched with an external I/F signal. A signal output from the selector 506 is input to a color-space-compression&ground-removal&LOG converting portion 507 and a ground removing portion 514. The signal input to the ground removing portion 514 undergoes ground removal and then input to a black-character determining portion 515 for determining a black character of an original in the original or not to generate a black character signal from the original. Moreover, the color-space-compression&ground-removal&LOG converting portion 507 to which an output of the other selector 506 determines whether space compression is kept in a range in which a read image signal can be reproduced by a printer. When the space compression is kept in the range, the portion 507 leave the space compression as it is. When the space compression is kept in the range, the portion 507 corrects the space compress so as to enter the range in which an image signal can be reproduced by the printer. Then, the portion 507 performs ground removal processing to convert RGB signals into YMC signals by a LOG converting portion. Moreover, to correct a signal generated by the black character determining portion 515 and its timing, the timing of an output signal of the color-space-compression&ground-removal&LOG converting portion 507 is adjusted in accordance with a delay 508. Moires are removed from these two types of signals by a moiré removing portion 509 and power-varied in the main scanning direction by a power varying portion 510. Symbol 511 denotes a UCR&masking&black-character reflecting portion. In the case of signals processed by the power varying portion 510, YMCK signals are generated from YMC signals by UCR processing, corrected to signals suitable for outputs of a printer b a masking processing portion and determination signals generated by the black character determining portion 515 are fed back to YMCK signals. A signal processed by the UCR&masking&black-character reflecting portion 511 is adjusted in density by a Y correcting portion 512 and then, smoothed or edge-processed by a filter portion 513. The above processed image data is stored in a page memory portion 516 and output to a printer portion in accordance with the image forming timing of the printer portion.

Then, a configuration of a color printer portion 2. In FIG. 1, symbol 250 denotes a printer controlling portion which serves as a receiving port of a control signal from the CPU 301 on the controlling portion 100 serving as a controlling portion of the whole image forming apparatus. The controlling portion 100 temporarily stores read image data in the memory 302 on the controlling portion by executing the already-described image read control for the a color reader portion 1 and transmits the image data in the memory to the printer controlling portion 250 as image data signals by making the data synchronize with a video clock.

The printer portion performs the operation described below in accordance with a control signal output from the printer controlling portion 250. Symbol 201 denotes a laser scanner for emitting a laser beam corresponding to an image data signal to a photosensitive drum 202 in the main scanning direction by a polygon mirror. An electrostatic latent image formed on the photosensitive drum 202 reaches a sleeve position of one color among various colors of a four-color developing rotary in accordance with the clockwise rotation of the photosensitive drum 202. Toner corresponding to the potential amount formed between the surface of the photosensitive drum 202 provided with an electrostatic latent image and a developing sleeve face to which a developing bias is applied is flown to the surface of the photosensitive drum 202 from each color developing apparatus 203 and the electrostatic latent image on the surface of the photosensitive drum 202 is developed.

The toner image formed on the photosensitive drum 202 is transferred to an intermediate transfer member rotating counterclockwise in accordance with the clockwise rotation of the photosensitive drum 202. In the case of black single-color images, images are sequentially formed on and primary-transferred onto an intermediate transfer member 205 by keeping a predetermined time interval. In the case of full color images, positioning of the sleeve of a developing rotary is applied to an electrostatic latent image corresponding to each color on a photosensitive drum, each electrostatic latent image is developed and primary-transferred, and after the intermediate transfer member 205 rotates four turns, that is, when four colors are primary-transferred, primary transfer of the full color image is completed.

Cassettes (upper-stage cassette 208, lower-stage cassette 209, third-stage cassette 210 and fourth-stage cassette 211) are picked up by pickup rollers 212, 213, 214 and 215 of the cassette stages, recording sheets conveyed by sheet feed rollers 216, 217, 218 and 219 are conveyed up to a resist roller 221 by longitudinal part conveying rollers 222, 223, 224 and 225. In the case of manual sheet feed, recording sheets piled up on a manual sheet feed tray 240 are conveyed up to the resist roller 221 by a manual sheet feed roller 220. Then, with a timing of completing transferring to the intermediate transfer member 205 a recording sheet is conveyed between the intermediate transfer member 205 and a secondary transfer roller 206. Thereafter, the recording sheet is held between the secondary transfer member 206 and intermediate transfer roller 205 and conveyed in the fixing-apparatus direction and contact-bonded to the intermediate transfer member 205, and a toner image on the intermediate transfer member 205 is secondary-transferred to the recording sheet. The toner image transferred to the recording sheet heated and pressured by the fixing roller and pressure roller 207 and fixed to the recording sheet. Transfer residual toner left without being transferred to the recording sheet on the intermediate transfer member 205 is cleaned in accordance with the post-processing control in the latter half of an image forming sequence by scraping the surface of the intermediate transfer member 205 with a cleaning plate 230 which can be contacted with or removed from the surface and scratching the transfer residual toner from the surface of the intermediate 205. Residual toner is scratched from the drum surfaced by a blade 231 in the photosensitive drum unit and conveyed up to a waste toner box 232 integrated in the photosensitive drum unit. Moreover, positive- and negative-polarity residual toners which are unexpectedly attracted to the surface of the secondary-transfer roller is completely cleaned by alternating applying a secondary transfer positive bias and a secondary transfer negative bias, attracting the residual toners of the both polarities onto the intermediate transfer member 205, and scratching the residual toners by the intermediate-transfer cleaning plate 230 and the post-processing control is completed.

The recording sheet on which an image is fixed is discharged toward a sheet discharge roller 233 by changing the direction of a first sheet-discharge flapper 237 to the first sheet-discharge direction in the case of first sheet discharge. In the case of second sheet discharge, the recording sheet is discharged toward a sheet discharge roller 234 by changing directions of first sheet discharge flapper 237 and second sheet discharge flapper 238 to the second sheet-discharge roller direction. In the case of third sheet discharge, reverse operation is once performed by a reverse roller 235. Therefore, directions of the first sheet discharge flapper and second sheet discharge flapper are changed to the direction of the reverse roller 235 to reverse the recording sheet. After the recording sheet is reversed by the reverse roller 235, the direction of a third sheet discharge flapper is changed to the third sheet discharge direction and the recording sheet is discharged toward a third sheet discharge roller 236. In the case of both-side sheet discharge, the recording sheet is once reversed by the reverse roller 235 as with the case of the third sheet discharge, the direction of the third sheet discharge flapper is changed to the both-side-unit direction, and the recording sheet is conveyed to a both-side unit. The recording sheet is once stopped when a predetermined time passes after the sheet is detected by a both-side sensor and then, when an image is prepared, the recording sheet is fed again.

(Toner Replenishing Mechanism)

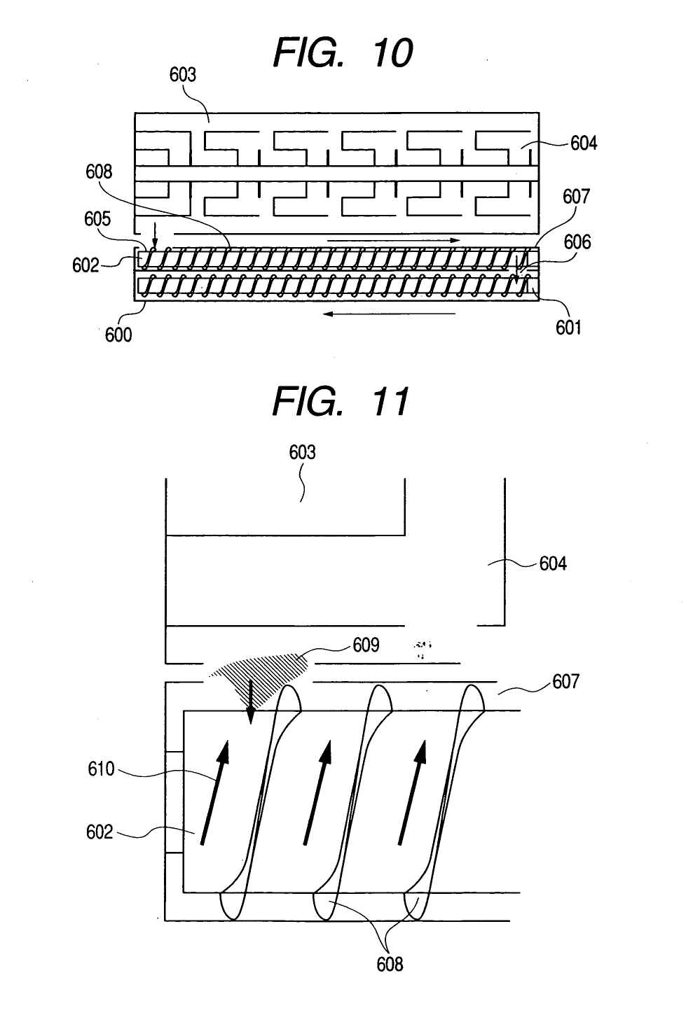

FIG. 10 is an illustration showing schematic views of cross sections of sides of the toner container and developing apparatus of this embodiment. Symbol 600 denotes the developing portion of the developing apparatus, 603 denotes a toner container, and 607 denotes a toner replenishing route serving as a tubular toner-conveying route. Symbol 604 denotes a wing for sending toner, 605 denotes a replenishing port and a toner-replenishing-route entrance in the toner container, and 606 denotes a replenishing port in the toner replenishing route for dropping toner to the developing portion of the developing apparatus from the toner replenishing route. Symbol 602 denotes a toner conveying screw for conveying toner through the toner replenishing route, in which a spiral wing 608 is wound on the central axis so as to convey toner up to the replenishing port 606 in the toner replenishing route along the portion of the spiral wing 608 by rotating the toner conveying screw 602. The toner conveying screw 602 is rotatably journaled by being separated by a predetermined distance so as not to contact with the inner periphery of the toner replenishing route in order to prevent toner from becoming coarse grain. Symbol 601 denotes an agitating screw for uniformly replenishing the toner in the developing portion 600 in the developing apparatus in the main scanning direction. Arrows in FIG. 10 denote movement directions in which toner is replenished. Toner 609 replenished to the developing portion 600 flows through the developing portion 600 while being agitated by the agitating screw 601.

Because a rotational developing rotary sequentially moves to developing positions of colors for forming an image under printing, the rotational developing rotary rotates by one turn without fail when forming a full color image. While the rotational developing rotary rotates by one turn, the developing unit of each color becomes the state shown in FIG. 10 at a predetermined position different for each color. In this case, toner drops by its own weight through the replenishing port in the toner container and thereby, the toner is replenished into the toner replenishing route predetermined amount by predetermined amount. FIG. 11 shows an enlarged view of the toner operation at the above timing. The replenished toner 609 drops to a position nearby the entrance of the toner replenishing route by its own weight (downward arrow ↓ in FIG. 11). Moreover, when the rotational developing rotary is present at a developing position under printing, the toner conveying screw 602 rotates in the direction shown by an arrow 610 in FIG. 11 and thereby, toner is conveyed to the replenishing port 606 in the toner replenishing route along the spiral wing 608.

(Toner Replenishment Control Under Printing)

Under printing, a toner replenishment amount is basically decided in accordance with image data information. The image data information denotes basically an integrated value obtained by integrating the information data for toners of various colors every pixel for each page. Toner consumption of each color is estimated in accordance with the integrated value to decide a toner replenishment amount. To replenish the decided toner replenishment amount, an operation for driving the toner-conveying replenishing screw 602 of the toner replenishing mechanism in FIG. 11 for a predetermined time and then stopping the mechanism is assumed as one cycle in the case of the replenishment control of this embodiment to calculate a toner replenishment amount in blocks by assuming the one cycle as a block. Thus, it is possible to control an amount of toner actually replenished in accordance with the number of blocks. Therefore, it is possible to easily determine how toner is consumed as a whole and easily estimate replenishment fluctuation compared to the case of simply replenishing toner for a replenishment time. Moreover, for a toner replenishment amount, a phenomenon that toner replenishment is too late for an actual necessary toner amount or a phenomenon that toner is excessively replenished occurs when continuous printing different in image density duty is performed in accordance with only an estimated toner replenishment amount. Therefore, colors are corrected every block replenishment (patch detection control) by forming a patch for each color on the photosensitive drum 202 in FIG. 1 every predetermined interval and directly detecting a toner density.

FIG. 4 shows a toner replenishment amount correction flow according to patch detection. Toner replenishment amount correction (S01) according to patch detection is determined in accordance with whether printing is performed at a predetermined interval during printing. When determining whether printing of a predetermined number of sheets is completed (S02) and printing of a predetermined number of sheets is completed, patch detection is executed synchronously with the next page (S04). Moreover, when printing of a predetermined number of sheets is not completed but an image having an image density duty is formed under continuous printing, necessary toner replenishment amount increases by an amount necessary for the image. Therefore, by assuming the above case, it is determined whether toner is replenished by a predetermined number of blocks (S03) to execute patch detection when toner is replenished by a predetermined number of blocks (S04). In the case of this embodiment, it is possible to form a patch for executing patch detection at the front end of each color image when forming a full color image. Therefore, it is possible to execute patch detection synchronously with full-color image formation. As a result of executing patch detection, detecting a formed patch, and calculating a patch density, the patch density is compared with a target patch density previously decided for each color to calculate a difference from the target density (S04). It is determined whether the calculated patch density is higher than the target density (S05). When it is determine that the calculated patch density is higher than the target density, a necessary number of toner blocks to be replenished held at the timing are cleared (S06).

When it is determined that the calculated patch density is lower than the target density, an additional correction amount is calculated in accordance with the difference from the target density calculated in S04 to additionally correct a toner replenishment amount (S07) and the toner replenishment amount correction according to patch detection is completed (S08).

(Toner-Absence Detecting Method Under Printing)

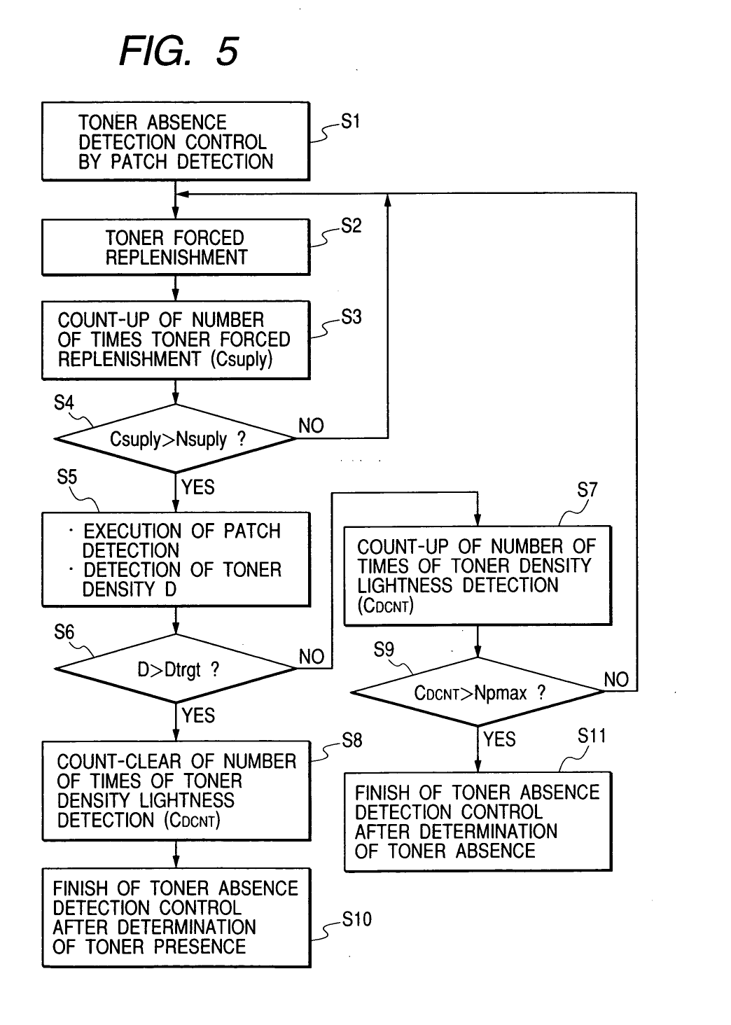

The toner-absence detecting method of this embodiment is executed by the patch detection described for the above toner replenishment control. Patch detection is normally executed to correct a toner replenishment amount. However, when a residual toner amount is small, a toner density detected by patch detection also lowers. Therefore, this phenomenon is used. FIG. 5 shows a toner-absence detection control flow. Patch detection control is executed when a predetermined interval is reached or the number of toner blocks to be replenished reaches a predetermined number of blocks. In this case, when it is detected that the patch density is low, toner-absence detection control is executed (S01). Toner replacement is first forcibly executed (S02), the forcible toner replacement frequency is counted (S03), and forcible toner replacement is repeatedly executed until a predetermined forcible replacement frequency Nsuply is completed (S04). After the predetermined forcible replacement frequency is completed, patch detection is executed to calculate the then patch density D (S05). The patch density D is compared with a target patch density Dtrgt (S06). When the patch density D is higher than the target patch density Dtrgt, it is determined that toner is present to clear a toner-density detection frequency CDCNT. To forcibly execute toner replacement, a toner density must return when toner is present. However, when a residual toner amount is small or toner is absent, a toner density must not easily return. Therefore, when the patch density D is lower than the target patch density Dtrgt, the toner density detection frequency CDCNT is counted up (S07) to repeatedly execute toner replacement from the forcible toner replacement. When the patch density D is continuously lower than the target patch density Dtrgt up to a predetermined frequency Npmax, it is substantially determined that toner is absent. By using the above configuration, it is possible to detect toner absence also in a system having no residual-toner-amount detecting sensor.

(Residual Toner Amount Detecting Method Under Printing)

The residual toner amount detecting method of this embodiment is executed by integrating the toner block replacement frequency described for the above toner replacement control. It is previously decided through an experiment or the like what value a toner block replacement frequency has in terms of the above block replacement unit before toner runs out. When assuming the frequency as A (number of blocks) and an integrated frequency of actually-executed block replacement as B (number of blocks), the following expression is used.

Residual amount (%)=(A−B)/A×100

In the case of this embodiment, it is determined that a residual toner amount is small when the residual toner amount is lower than 25%.

(Operations of Rotational Developing Rotary When Detecting Toner Absence)

In the case of this embodiment, when toner absence is detected by the toner absence detecting method while a job is executed, an image is formed on a sheet currently fed to discharge the sheet, sheet feeding is stopped for sheets from the above sheet downward, post-rotation processing such as cleaning is executed for the process processing relating to image formation, and a motor load currently driven is stopped.

The currently-driven motor load also includes a developing rotational rotary. When the normal job is completed, a rotational developing rotary not at the developing position of each color is moved up to the takeout position of a color for toner absence simultaneously with the post-rotation processing of process processing though the rotary is normally moved up to the home position which is not the developing position for each color and the rotation reference position of the rotary.

In addition, in the present embodiment, the toner-absence detecting is performed sequentially with respect to the respective toner containers of yellow, magenta, cyan and black toner. And even if the toner container which is determined as “toner absence” is detected in the middle of the toner-absence detecting, the toner-absence detecting is performed as one process until the toner-absence detecting is completed with respect to all of the toner containers.

Accordingly, according to the structure of the present embodiment, as described below, when the plurality of the toner containers are determined as “toner absence” at the same time, it can shorten the time required to replace all of the toner containers which are determined as “toner absence,” as much as possible.

Because, when one toner container is replaced and the door for exchange is closed, the CPU controls so that the operation for preparation required to perform the image forming such as the toner presence/absence detection with respect to the exchanged toner container is performed.

Moreover, in the case of toner absence of only one color, the toner container of a color whose toner is absent is moved to the takeout position.

Furthermore, when toner absences of a plurality of colors occur at the same time and black is included in the colors whose toners are absent, a black toner container is preferentially moved to the replacement position (takeout position) together with the rotational developing rotary. This is because when black toner runs out, the printer portion 1 of this embodiment basically becomes a state not capable of forming an image.

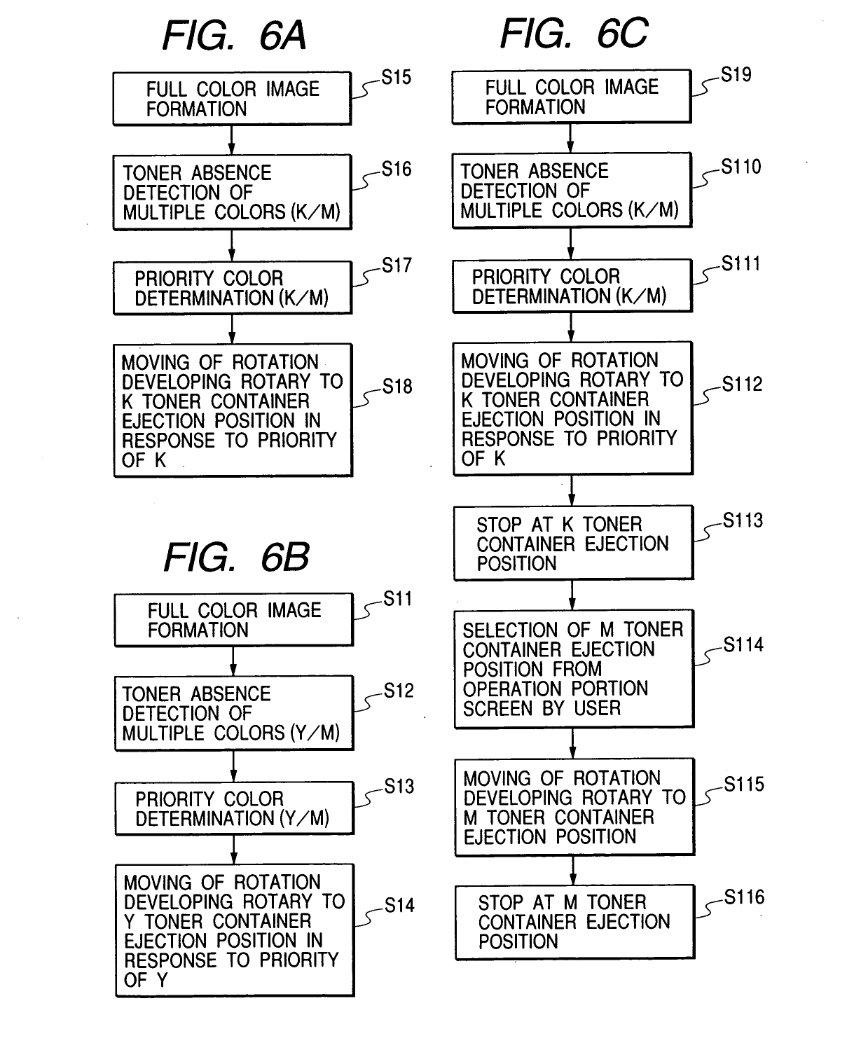

FIG. 6A shows a flow of a toner-container takeout position of a developing rotary when black and magenta toners run out.

When black is not included in a color whose toner runs out, that is, among a plurality of colors other than black whose toner containers substantially include no toner, the toner container of the nearest color for control is preferentially moved to the takeout position. That is, a toner container nearer to a toner container takeout position (toner container nearest at the upstream side of a toner-container takeout position in the rotational direction of a developing rotary) when starting a toner container replacing step is preferentially moved to accelerate replacement of a corresponding toner container at a liquid-crystal displaying portion located above an image forming apparatus. Thereafter, a user opens the replacement door of the image forming apparatus, takes out the corresponding toner container located at the takeout position of the developing rotary, and replaces the toner container with a new toner container. Therefore, because the toner container of the nearest color among colors whose toners run out is moved to the takeout position, the user does not have to wait and it is not necessary to wastefully rotate the developing rotary. That is, it is possible to minimize the time required for the toner-container replacing step.

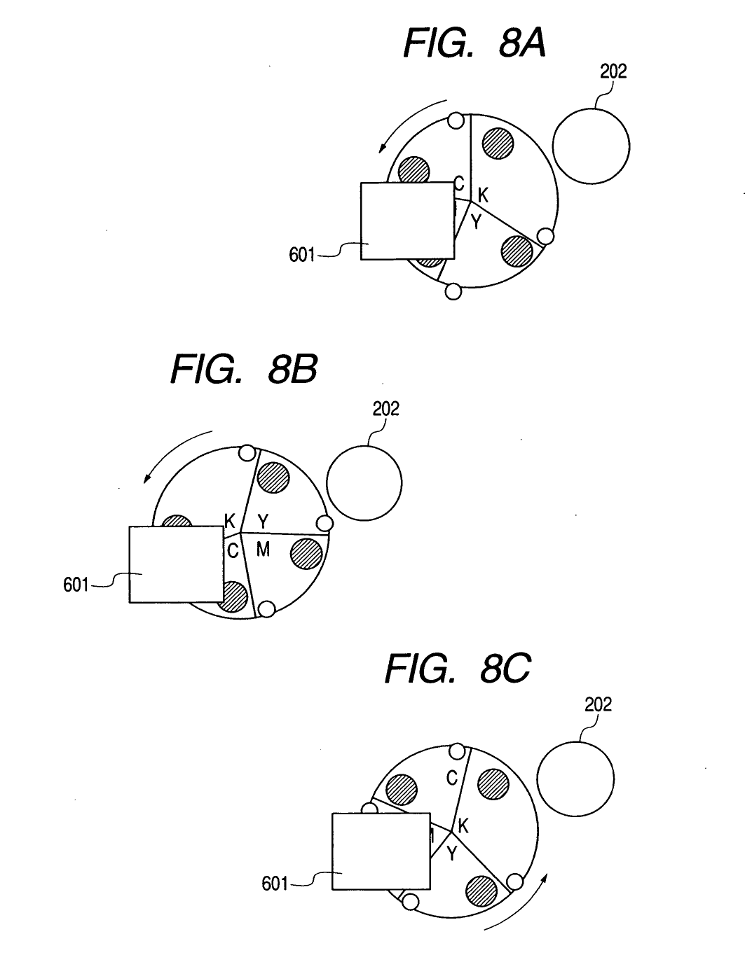

Image formation in this embodiment is executed in order of yellow, magenta, cyan and black. FIG. 8A shows a state in which a developing rotary is present at the normal home position and FIG. 8B shows a developing rotary position state after full color image formation is completed. In FIGS. 8A and 8B, a gray round portion shows a toner container of each color. When considering the control in which the rotational speed and rotational direction of a developing rotary are restricted in only one direction on completion of the black image formation, the color order nearest to a toner-container takeout position after forming an image is shown as black, yellow, magenta and cyan illustrated in FIG. 8B. That is, the priority for taking out toner containers is shown below.

Black→Yellow→Magenta→Cyan

FIG. 6B shows a flow for deciding a toner container takeout position of a developing rotary when toners of yellow and magenta run out at the same time.

Moreover, it is also allowed to use a configuration of moving an apparatus to the position for taking out the toner container of a preferential color by considering the image forming job of the next black single color and assuming a color whose stop position is the nearest to a black developing position as a preferential color immediately before stopping the apparatus when toner absences of a plurality of colors except black are simultaneously detected. In this case, there are market needs for executing a black single-color job even when color toners are absent and it is an object to set the first print-out time or first copy-out time of a black single-color job when there is no color toner as early as possible. In this case, the priority of colors under toner absence is shown below.

Black→Magenta→Yellow→Cyan

FIG. 8C shows a developing rotary position at the magenta-toner takeout position. When starting printing at the position in FIG. 8C, it is possible to earliest reach the black toner developing position compared to the case of starting with the toner-container takeout position of other color.

After replacing toner containers, toner container replacement and toner initialization control are executed every color by executing the toner initialization control of a color whose toner container is replaced and confirming the return of a toner density. After the toner density returns by the toner initialization control, the toner container is stopped at a toner-absent color container having the second priority. Details of the toner initialization control will be described later.

(Toner Container Replacement Determining Method Under Toner Absence Detection)

In the case of this embodiment, a dedicated sensor for detecting whether a toner container is taken out is not mounted.

Therefore, in the case of this embodiment, when a toner container receiving the toner of a color whose toner substantially runs out in accordance with the above method is present at the takeout position, a CPU determines that a user replaces toner containers by detecting that a small window serving as an opening/closing door which can be freely opened or closed in order to take out a toner container from a developing rotary is released from a state in which the window is closed and the opening opens.

That is, in the case of this embodiment, the CPU determines “replacement of toner containers” in accordance with the “small window opening operation.”

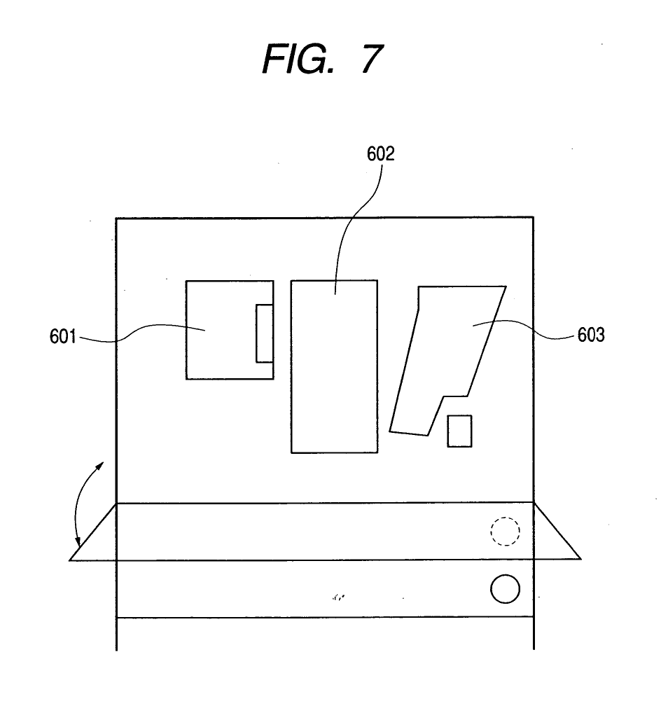

FIG. 7 shows an outline of a toner-container-takeout small window which must be opened without fail when replacing toner containers. Symbol 701 denotes a small window for taking out a toner container, 702 denotes a waste toner receiving box, and 703 denotes a photosensitive drum unit. The toner container is taken out by opening the toner-container takeout small window 701 to this side and turning a not-illustrated toner-container replacing lever seen by opening the small window. When every door closes after replacing toner containers, the toner initialization control of the color whose toner runs out is executed in addition to the preparation processing up to a printing acceptable state which is normally executed. Details of the toner initialization control will be described later.

(Initialization Control After Replacing Color Toner Container Including No Toner)

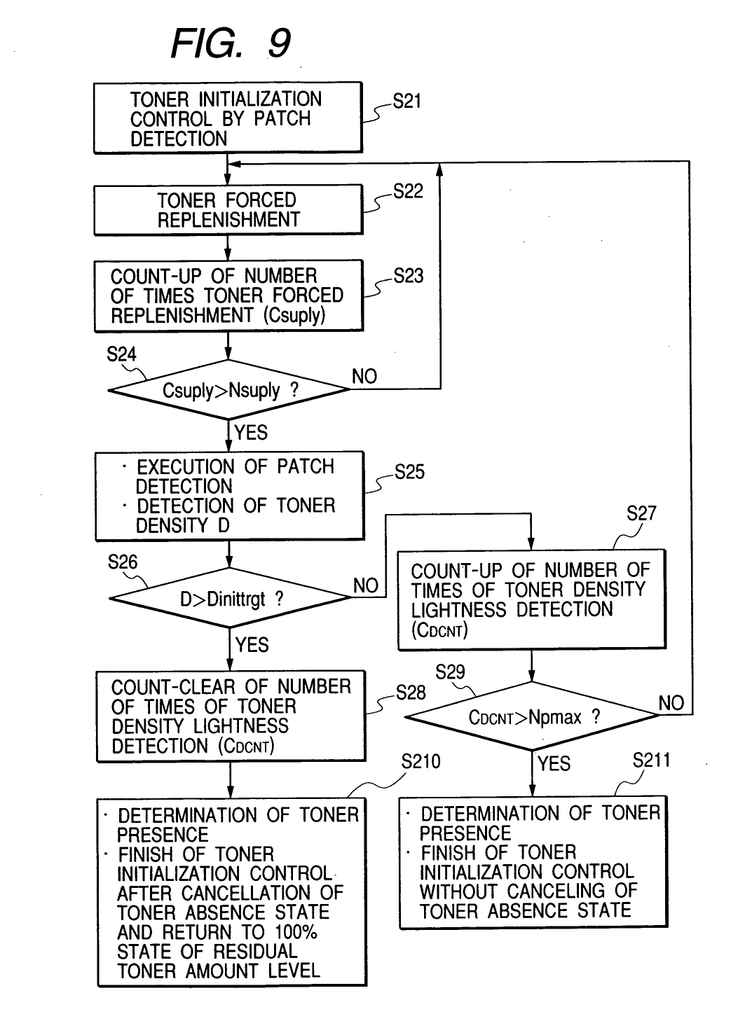

After replacing a color toner container in which toner runs out, it is necessary to execute the processing for determining whether a toner density returns without fail. When it is possible to accurately detect a residual toner mount at the toner replenishing port in a not-illustrated developing apparatus, it is not necessary to detect that the toner density returns. In the case of this embodiment, however, the above patch detection control is executed because a sensor for accurately detecting the residual toner amount at the toner replenishing port in the developing apparatus is not included. Basically, toner is forcibly replenished into the developing apparatus and patch detection control is executed to detect whether a toner density reaches a target density at the time of predetermined return as with the case of toner absence detection. FIG. 9 shows a toner initialization control flow. The toner initialization control is different from the normal toner absence detection control in that a target density Dinittrgt to be compared with a patch density D detected through patch detection is made lower than the target density Dtrgt under toner-absence detection control. This is because the fact that a target density is extremely raised when toner returns becomes a user claim that an image density fluctuation increases. By lowering a target density compared to the case of toner-absence detection control, a toner density to be returned is lowered. When reaching the target density Dinitrgt, the toner absence state is cancelled to complete the toner initialization control.

Embodiment 2

(Toner Container Replacement Positioning Control According to Selection by User)

When toner absences of a plurality of colors occur at the same time and a toner-absent color is selected through key input by a user from an operating portion, the toner container of the selected color is moved to a takeout position. Also when a preferential color is once determined and the toner container of another color is moved to the takeout position, the toner container of the color selected by the user is moved to the takeout position. FIG. 6C shows a flow for moving the toner container of a color selected by a user to a takeout position. Though a toner container receiving black toner is once moved to the takeout position, the toner container receiving magenta toner is moved to the takeout position through key selection at the operating portion by the user. In this case, for the toner initialization control to be executed immediately after replacing toner containers, it is a matter of course to give priority to the toner initialization on the toner of the color selected by the user. After a toner density is returned by the toner initialization control of the color selected by the user, the toner container of another toner-absent color having the next priority is moved to the takeout position and stopped. Details of the toner initialization control are previously described.

(Processing after Replacing Toner Containers in the Case of Forcible Replacement of Toner-Present Colors by User)

When it is determined through residual toner detection that toner is little and thereby, toner containers are replaced to execute the toner initialization control, a mixing rate between toner and carrier in the developing apparatus is greatly changed and thereby a sudden image-density fluctuation occurs due to forcible toner replenishment executed through the toner initialization control because toner is present in the developing apparatus though it is little at this point to time. Moreover, the same is applied to the case in which toner is present and it is forcibly replaced. Therefore, in the case of this embodiment, when it is determined that is at least present, toner forcible replacement color is selected by the user from the operating portion and the toner-container replacement takeout small window is detected and thereby, it is determined that the user has an intention of replacing toner containers and it executed only to return a residual toner level to a full state so as not to execute the toner initialization control.

In the case of the above embodiment, though a “state in which a toner container is determined as a toner-absent toner container” is expressed, this does not point only that toner in a toner container is completely absent but in the case of the present invention, even a case in which toner slightly remains in a toner container is referred to as “toner absence.” That is, a toner container when it may be better to replace toner containers is referred to as “toner absent state.”

Moreover, the above embodiment is constituted so that a toner container to be replaced by a user at an operating portion can be selected. However, it is also allowed to use the following configuration in addition to or instead of the above configuration.

Specifically, the configuration is a configuration in which a toner container to be replaced by a user is selected from a computer network-connected with an image forming apparatus and a signal showing the specified toner container is input to the CPU 301 through a network and the interface portion 116 set to the image forming apparatus so as to control operations of a developing rotary in accordance with the input signal.

Moreover, a system for detecting a residual toner amount in a toner container is not restricted to the above configuration but it is allowed to use a configuration of setting an optical sensor having a light-emitting portion and a light-detecting portion nearby a developing rotary, irradiating light toward a toner container from the light-emitting portion of the optical sensor and detecting the light reflected from the toner container by the light-detecting portion. Furthermore, it is allowed to use a system of using that image information of an original image (when functioning as a printer, image information transmitted from a network-connected computer is used) corresponds to the used amount of a developer and thereby detecting a residual toner amount in a toner container. The image information signal undergoes various signal processings and then it is output to a laser scanner 201 serving as the above exposing apparatus so that an electrostatic latent image corresponding to image information is formed on a photosensitive member.

It is also allowed to set a plurality of sensors for respectively detecting a residual toner amount in a toner container every a plurality of toner containers.

As described above, according to each of the above embodiments, it is possible to provide an image forming apparatus improved in usability and capable of shortening the time required for a toner replacing step as soon as possible or efficiently executing an image forming job after replacing toner containers. Moreover, it is possible to provide an image forming apparatus not confusing a user when replacing toner containers.

What is claimed is:

1. An image forming apparatus comprising:
a plurality of toner containers for receiving toners of colors different from each other;
a movable member holding the toner containers and freely moving in a route including a replacement position for replacing toner containers;
detecting means for detecting residual toner amounts in the toner containers; and
selecting means for selecting a toner container to be preferentially moved to the replacement position when a plurality of toner containers substantially determined as toner-absent toner containers is detected by the detecting means.

2. The image forming apparatus according to claim 1, wherein
the selecting means preferentially selects a toner container nearest to the replacement position when staring a toner container replacing step among a plurality of toner containers determined as toner-absent toner containers.

3. The image forming apparatus according to claim 1, wherein
the selecting means preferentially selects a toner container in accordance with the color of toner received by the means.

4. The image forming apparatus according to claim 3, wherein
when a toner container receiving achromatic toner is included in a plurality of toner containers substantially determined as toner-absent toner containers by the detecting means, the selecting means preferentially selects the toner container receiving the achromatic toner.

5. The image forming apparatus according to any one of claims 1 to 4, wherein
controlling means is included which controls whether to execute an image forming job in accordance with the type of an image after replacing the first toner container among a plurality of toner containers substantially determined as toner-absent toner containers by the detecting means and before replacing all the toner containers determined as toner-absent toner containers.

6. The image forming apparatus according to claim 5, wherein
when a toner container receiving achromatic toner is not included in a plurality of toner containers substantially determined as toner-absent toner containers by the detecting means, the controlling means inhibits execution of a full-color image forming job but allows execution of a black-and-white image forming job.

7. An image forming apparatus comprising:
a plurality of toner containers for receiving toners of colors different from each other;
a movable member holding the toner containers and freely moving in a route including a replacement position for replacing toner containers; and
operating means for operating the movable member so that a toner container selected by an operator moves to the replacement position.

8. The image forming apparatus according to claim 7, wherein
the following means are included: detecting means for detecting residual toner amounts in the toner containers and means for operating the movable member so that a toner container substantially determined as toner-absent toner containers by the detecting means moves to the replacement position.

9. The image forming apparatus according to claim 8, wherein
when a toner container selected by an operator is included in a plurality of toner containers substantially determined as toner-absent toner containers by the detecting means, the toner container selected by the operator is preferentially moved to the replacement position.

10. The image forming apparatus according to claim 7, wherein
inputting means is included to which a signal showing a toner container selected by an operator is input.

11. The image forming apparatus according to claim 10, wherein
an operating portion capable of selecting a toner container is included, and
the operating portion outputs the signal to the inputting means.

12. An image forming apparatus comprising:
a plurality of-toner containers for receiving toners of colors different from each other;
a movable member holding the toner containers and freely moving in a route including a replacement position for replacing toner containers;
detecting means for detecting residual toner amounts in the toner containers; and
wherein after the residual toner amount detection operation for the respective toner containers by said detecting means is performed, the toner container determined as toner absent toner is made to move to said replacement position.
